(19) United States
(12) Patent Application Publication
(10) Pub. No.: US 2010/0060527 A1
(43) Pub. Date: Mar. 11, 2010

(54) ELECTROMAGNETIC BAND GAP TUNING USING UNDULATING BRANCHES

(75) Inventors: Tae Hong Kim, Austin, TX (US); Moises Cases, Austin, TX (US); Bhyrav Murthy Mutnury, Austin, TX (US); Stephen H. Carman, Austin, TX (US)

Correspondence Address: STREETS & STEELE - IBM CORPORATION, 13100 WORTHAM CENTER DRIVE, SUITE 245, HOUSTON, TX, 77065, US

(73) Assignee: International Business Machines Corporation, Armonk, NY (US)

(21) Appl. No.: 12/207,597

(22) Filed: Sep. 10, 2008

(51) Int. Cl. H01Q 1/38; H01Q 1/00; H01P 11/00

(52) U.S. Cl. 343/700 MS; 343/722; 29/600

(57) ABSTRACT

Embodiments of the invention include electromagnetic band gap (EBG) structures having undulating branches to tune the resulting stopband. A periodically patterned structure of conductive patches are interconnected by the undulating branches. Physical parameters of the undulating branches, such as the number of undulations or “turns” per branch, may be selected to tune the stopband in an effort to achieve a target stopband. Accordingly, embodiments of the invention also include methods of designing and manufacturing an EBG structure using undulating branches.

### BACKGROUND OF THE INVENTION

1. Field of the Invention

The present invention relates to noise suppression and isolation, and in particular, to controlling the range of stopband frequencies resulting from a periodically patterned structure.

2. Background of the Related Art

In modern high-speed and mixed-signal electronic systems, isolating power/ground noise coupling between circuits on a circuit board is a concern. If not controlled or accounted for, the noise coupling between circuits may result, for example, in false switching for digital circuits and malfunctioning of analog circuits. Therefore, the suppression of noise coupling has been an area of research and development. One approach to suppressing noise coupling is to provide a split power/ground plane. However, the split power/ground plane requires the use of multiple DC power supplies, which increases cost.

Another approach to suppressing noise coupling in electronic circuits is the use of periodically patterned structures. Periodically patterned structures include photonic band gap structures and electromagnetic bandgap (“EBG”) structures. EBG structures exhibit stopband properties tending to prevent or reduce electromagnetic propagation in the range of stopband frequencies. Unlike the approach of using a split power/ground plane, EBG structures can be used with circuits sharing a common power supply.

One challenge associated with using an EBG structure is controlling the bandwidth of the resulting stopband frequencies. The stopband frequencies are dependent, in part, on the size of the individual EBG “patches” that comprise an EBG structure. For a given patch shape, increasing the patch size generally decreases the stop band frequencies. However, increasing the individual patch size to achieve a desired range of stopband frequencies may require the EBG structure to be larger than an allotted design space.

### BRIEF SUMMARY OF THE INVENTION

A first embodiment of the invention provides a band gap structure, including a dielectric layer, a first conductive layer disposed on a first side of the dielectric layer, and a second conductive layer disposed on an opposing side of the dielectric layer. The second conductive layer includes an array of spaced-apart patches interconnected by a plurality of branches. Each branch connects two adjacent patches and includes one or more undulations such that the length of each branch exceeds the physical spacing between the adjacent patches.

A second embodiment of the invention provides a method of designing a band gap structure. A periodic structure is selected, including conductive patches spaced apart in a conductive layer. Physical parameters are selected for undulating branches used to connect the conductive patches for tuning a resulting stopband.

A third embodiment of the invention provides a method of manufacturing a stopband structure, including forming a periodic structure of spaced-apart conductive patches interconnected by undulating branches each having a branch length exceeding the physical spacing between adjacent patches.

### BRIEF DESCRIPTION OF THE SEVERAL VIEWS OF THE DRAWINGS

FIG. 1 is a perspective view of a section of an electronic band gap (EBG) structure according to an embodiment of the invention.

FIG. 2 is an enlarged, plan view of six patches from the EBG structure of FIG. 1 that are coupled by branches, wherein each branch has a single undulation or “turn.”

FIG. 3 is an enlarged view of one of the undulating branches having the single turn.

FIG. 4 is an enlarged, plan view of the six patches from the EBG structure, wherein each branch between adjacent patches has three turns.

FIG. 5 is an enlarged view of one of the undulating branches having three turns.

FIG. 6 is a plot of the stopband versus the number of turns in the branches connecting the patches in an EBG structure.

FIG. 7A is a schematic diagram of an undulating branch comprising smooth curves and no straight segments.

FIG. 7B is a schematic diagram of an undulating branch comprised of straight segments that meet at an angle of greater than 90 degrees.

FIG. 7C is a schematic diagram of an undulating branch comprised of straight segments that meet at less than ninety degrees.

FIG. 8 is a flowchart outlining a method of designing a band gap structure having a periodic structure of conductive patches interconnected with undulating branches.

FIG. 9 is a flowchart outlining a method of manufacturing a stopband structure for an electronic device according to another embodiment of the invention.

### DETAILED DESCRIPTION OF THE INVENTION

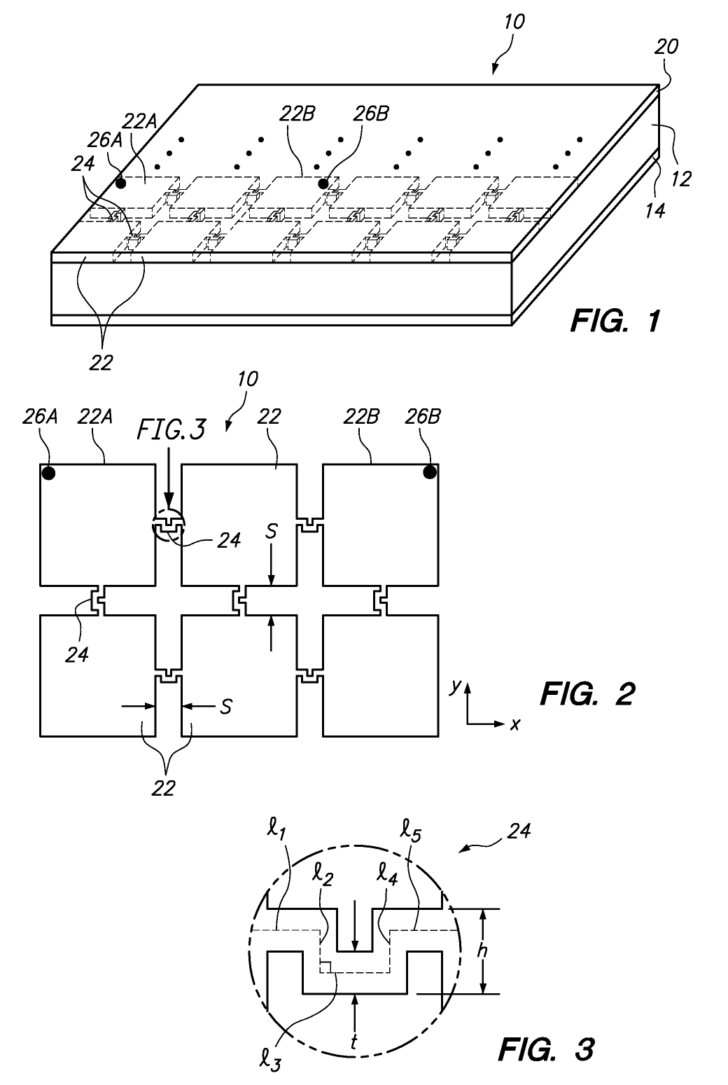

FIG. 1 is a perspective view of a section of a band gap structure 10 according to an embodiment of the invention. It will be assumed for the purpose of discussion that the band gap structure 10 is an electromagnetic band gap (“EBG”) structure 10. However, one skilled in the art will appreciate that the principles discussed with respect to the exemplary embodiments presented herein may be adapted to alternative types of band gap structures, such as photonic band gap structures. The EBG structure 10 has a multi-layer composition that includes a dielectric substrate or layer 12, a first conductive layer 14 disposed on a first side of the dielectric layer 12, and a second conductive layer 20 disposed on an opposing side of the dielectric layer 12. The layered structure of the EBG structure 10 may be manufactured, at least in part, using techniques for the manufacture of printed circuit boards (PCBs). The conductive layers may be deposited onto a dielectric substrate.

The dielectric layer 12 may include a substantially continuous layer of dielectric material, which acts as an electrical insulator between the first conductive layer 14 and the second conductive layer 20. The dielectric layer 12 may be formed of any of a variety of dielectric materials known in the art of printed circuit board (PCB) manufacturing. The dielectric layer 12 can be, for example, a dielectric material with a dielectric constant having a relative permittivity of about 2.2 to about 15, and/or a dielectric loss tangent of about 0.001 to about 0.3, and combinations thereof. The dielectric layer 12 can include, for example, FR-4 (“Flame Retardant 4”), ceramic, and combinations thereof. The dielectric layer 12 can have, for example, a thickness between about 1 mil and about 100 mils. The EBG structure 10 may be cured using a combination of temperature and pressure that causes the glass fibers in the dielectric layer to soften and bond together for strength and rigidity.

The first conductive layer 14 may be a substantially continuous conductive layer for use as a ground plane or a power plane. For example, the first conductive layer 14 can include a metal such as aluminum (Al), chromium (Cr), copper (Cu), palladium (Pd), platinum (Pt), or combinations thereof. The first conductive layer 14 may have, for example, a material with a conductivity between about 1×10̂6 S/m and about 6.1×10̂6 S/m. The first conductive layer 14 may have, for example, a thickness between about 1 mil and 10 mils.

Constituent materials of the second conductive layer 20 may be similar to materials used in the first conductive layer 14. In particular, the second conductive layer 20 can include, for example, a metal such as Al, Cr, Cu, Pd, Pt, or combinations thereof. The second conductive layer 20 may have, for example, a material with a conductivity between about 1×10̂6 S/m and about 6.1×10̂6 S/m. The second conductive layer 2 may have, for example, a thickness between about 1 mil and 10 mils. The second conductive layer 20 may be a ground plane or a power plane. For example, where the first conductive layer 14 is used as a ground plane, the second conductive layer 20 may be used as a power plane. Alternatively, where the first conductive layer 14 is used as the power plane, the second conductive layer 14 may be used as the ground plane.

The second conductive layer 20 has been etched to form an array of spaced-apart patches 22 interconnected by a plurality of undulating branches 24. Each branch 24 connects one patch 22 with an adjacent patch 22. The difference in surface area of the relatively large patches 22 as compared with the relatively small branches 24 imparts alternating sections of high and low characteristic impedances. In particular, each patch 22 in the second conductive layer 20 in combination with the substantially continuous first conductive layer 14 forms a parallel-plate waveguide having a comparatively lower characteristic impedance than a parallel-plate waveguide formed by each branch 24 in the second conductive layer 20 in combination with the substantially continuous first conductive layer 14. Thus, the alternating patches 22 and branches 24 form a two-dimensional LC (inductor-capacitance) network that serve as a low-pass filter (LPF) having a characteristic stopband, to isolate electromagnetic waves between circuits that are in electronic communication with the patches 22 of the EBG structure 10. A stopband is a band of frequencies between specified limits in which a circuit does not let signals through (or significantly reduces the amplitude of those frequencies to below a threshold value). As further explained below, the undulating shape of the branches 24 alters the stopband as compared with a baseline stopband that would result with straight branches. The physical parameters of the branches may be selected to tune the stopband.

A first patch 22A includes a first circuit 26A and a second patch 22B includes a second circuit 26B. Each circuit 26A, 26B may be, for example, a digital circuit or an analog circuit. The circuits 26A, 26B may be connected to the power plane through vias at respective “ports.” The EBG structure 10 may be part of a “mixed-signal system,” including both analog and digital circuits. For example, the first circuit 26A may be an analog circuit and the second circuit 26B may be a digital circuit. Digital circuits are often noisy, while analog circuits can be very sensitive to noise. For instance, radio frequency (RF) front-end circuits such as low noise amplifiers are configured to detect low-power signals, and consequently are very sensitive. A large noise spike in or near the operating frequency band of a sensitive analog circuit can desensitize the circuit or undermine its functionality. Therefore, the LPF characteristic of the EBG structure 10 is useful for isolating circuits, and in particular, to isolate analog circuits from digital circuits, to minimize noise coupling. The two circuits 26A, 26B are electronically coupled to different patches 22A, 22B of a power or ground plane in order to suppress noise coupling between the two circuits 26A, 26B. The LPF characteristics of the EBG structure 10 significantly attenuate the transmitted frequencies in the range of the bandgap associated with the LC network, so that the circuit 26A on the patch 22A is at least partially shielded from noise generated by the circuit 26B on the other patch 22B, and vice-versa.

FIG. 2 is an enlarged, plan view of six patches 22 from the EBG structure 10, including patches 22A and 22B, as interconnected by the undulating branches 24. Although not strictly required, the patches 22 in this embodiment are arranged in a rectangular array of evenly spaced patches in an x-y plane. Thus, the vertical (y) spacing between two vertically spaced patches 22 is the same as the horizontal (x) spacing between two horizontally spaced patches 22. The patches 22 have a rectangular shape, although other patch shapes may be selected, such as a rectangular shape, a polygonal shape, a hexagonal shape, a triangular shape, or a circular shape. The size and shape of the patches 22 affects the stopband. Generally, increasing the surface area (in the x-y plane) of each patch 22 will shift the stopband to a lower band of frequencies. However, there are practical limitations to increasing the size of the patches. An aspect of the invention, therefore, is directed to tuning the stopband resulting from the periodic structure of the EBG structure 10 by providing the branches 24 with an undulating shape.

FIG. 3 is an enlarged view of one of the undulating branches 24, which has a single undulation (alternatively referred to as a “turn”). Each turn is optionally U-shaped. Segments of the U-shaped turns in this embodiment are optionally straight, meeting at generally right angles. The branch 24 has a branch thickness “t” and a branch height “h.” The undulating shape of the branch 24 results in a branch length “1” that exceeds the physical spacing “s” between two adjacent patches 22. The increased branch length resulting from the use of an undulating branch shifts the stopband to a lower frequency range. A dashed line is provided to visualize the branch length “l.” The value of l is equal to the sum of the individual branch segments, represented by dashed-line segments l₁, l₂, l₃, l₄, and l₅. Generally, the branch length l for a branch having straight segments that meet at right angles may be computed as l=Σlᵢ, where lᵢ is the length of the i^{th} segment. The branch length for an undulating branch exceeds the spacing between adjacent patches, i.e., that l>s.

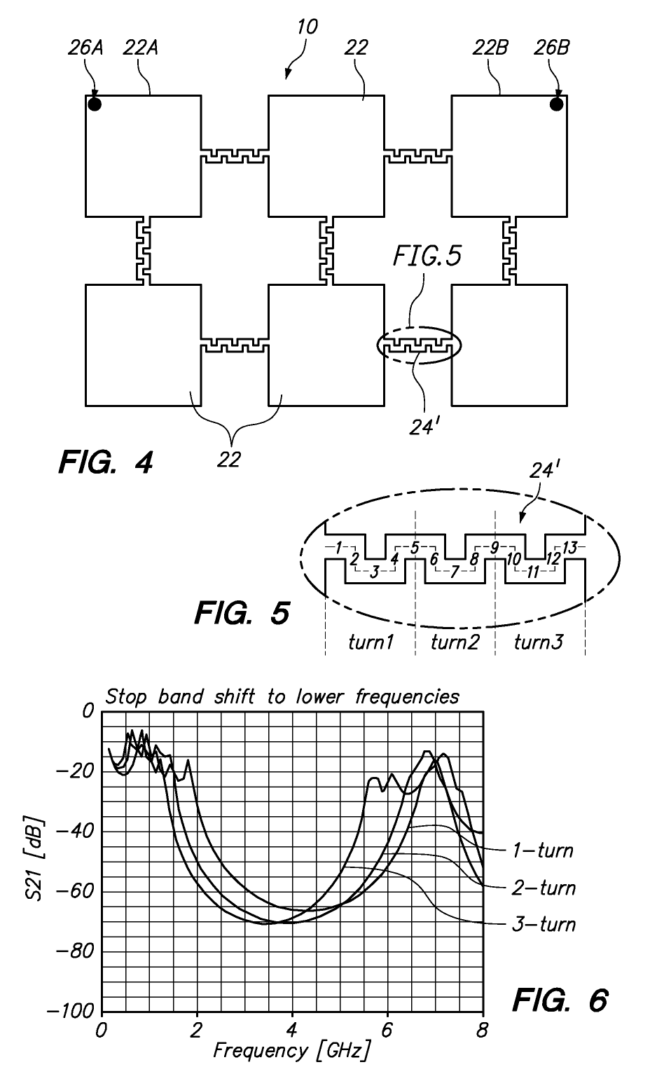

FIG. 4 is an enlarged, plan view of the six patches 22 from the EBG structure 10, wherein each branch 24′ has three turns. FIG. 5 is an enlarged view of one of the undulating branches 24′. The three turns are individually labeled “turn 1,” “turn 2,” and “turn 3.” Using the formula l=Σlᵢ, the branch length l would be equal to the sum of the thirteen segments that comprise the branch 24′. The increased number of turns increases the branch length, which shifts the stopband to lower frequencies than the stopband of the single-turn branch 24 of FIG. 3.

FIG. 6 is a plot “S21” of the stopband versus the number of turns in the branches connecting the patches in an EBG structure. A separate curve is plotted for each of a one-turn branch (e.g. the branch 24 of FIG. 3), a two-turn branch, and a three-turn branch (e.g. the branch 24′ of FIG. 5). The plot illustrates the shift in stopband resulting from changing the number of turns. The stopband of one-turn branch is at a lower frequency range than if non-undulating branches were used. The stopband of the two-turn branch is shifted to the left of the one-turn branch, indicating a lower stopband frequency range. The stopband of the three-turn branch is shifted to the left of the two-turn branch, indicating an even lower stopband frequency range.

It should be noted that the branch length may also be affected by physical parameters other than just the number of turns in a branch. For example, the branch length may be increased (and the stopband may be correspondingly decreased) by increasing the branch height h. For example, the branch length of the branch 24 (FIG. 3) or the branch 24′ (FIG. 6) may be increased for a given number of turns by holding the branch thickness t constant and increasing the branch height h. For a given patch spacing s and branch height h, increasing the number of turns may require decreasing the branch thickness, t. Changing the thickness t will change the isolation level of the stopband. Typically, reducing the thickness t results in better isolation level in the range of stopband frequencies. However, the stopband shift is dominantly affected by the branch length l, and not by the thickness t.

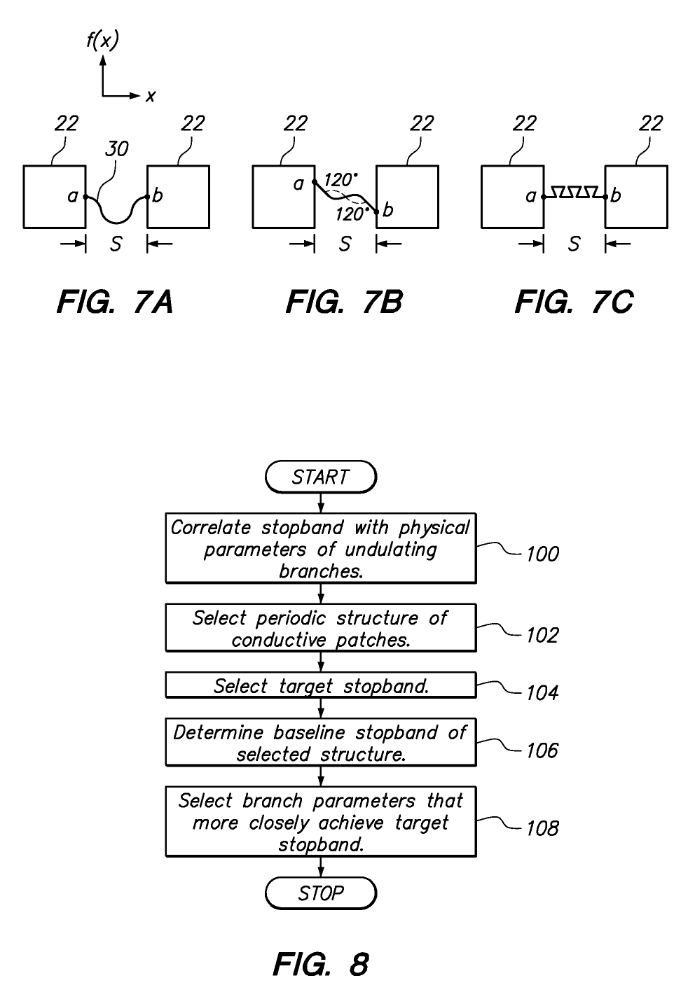

An undulating branch comprised of straight segments meeting at right angles, such as the branch 24 of FIG. 3 and branch 24′ of FIG. 5, provides an efficient structure for increasing the branch length to exceed the patch spacing. However, an undulating branch according to the invention is not required to be comprised of straight segments that meet at right angles. FIGS. 7A, 7B, and 7C illustrate non-limiting examples of other undulating branch shapes. FIG. 7A is a schematic diagram of an undulating branch 30 comprising smooth curves and no straight segments. The undulating branch 30 connects one patch 22 at a location “a” to an adjacent patch 22 at a location “b.” FIG. 7B is a schematic diagram of an undulating branch 32 comprised of straight segments that meet at an angle of greater than 90 degrees. The undulating branch 32 connects one patch 22 at a location “a” to an adjacent patch 22 at a location “b.” FIG. 7C is a schematic diagram of an undulating branch 34 comprised of straight segments that meet at less than ninety degrees. The undulating branch 34 connects one patch 22 at a location “a” to an adjacent patch 22 at a location “b.” As a result of the undulating shape, the length l of each branch 30, 32, 34 exceeds the spacing s between adjacent patches 22, thereby shifting the stopband to lower frequencies.

Due to the variances in shape that are possible for an undulating branch, a more general formula for the branch length that generally applies to an undulating branch may be expressed as:

$$l = {\int }_{a}^{b} \sqrt{1 + {[ {f}^{′} ( x ) ]}^{2}} d x$$

In the above equation, l is the branch length, a is the point of contact on one patch, b is the point of contact on the adjacent patch, and f(x) represents the shape of the undulating branch. While this equation may be applicable to many or most undulating branches, it may be possible to construct undulating branches within the scope of the invention that, despite having the same length as computed from this equation, result in different stopband tuning For example, it is possible to construct an undulating branch having whose branch thickness varies dramatically along its length, which may have a different effect on stopband than a constant-thickness branch having the same length.

The invention further encompasses, in various other embodiments, methods of circuit design and manufacture. For example, FIG. 8 is a flowchart outlining a method of designing a band gap structure having a periodic structure of conductive patches interconnected with undulating branches. The method is not limited to performing the steps in the order in which they appear in the flowchart. Also, the design process may be iterative, and steps or sequences of steps may be repeated to obtain a satisfactory combination of conductive patches and undulating branches.

In step 100, the stopband for an EBG structure is correlated with one or more physical parameters associated with the undulating branches used to interconnect patches in the EBG structure. For example, FIG. 6, discussed above, provides a sample correlation between the shift in stopband and the number of turns per branch for undulations having straight segments joined at right angles. The correlation may include any number of turns and the resulting stopband shift. The correlation may also include the effect on stopband associated with changing other physical parameters such as the shape of the branches, the shape of the individual undulations, the height of the undulations, or the thickness of the branches. Furthermore, correlations may be generated for different patch shapes and patch spacing. Step 100 may be repeated with different patch shapes and branch shapes to obtain a record (e.g. a physical or electronic database) describing the correlation of the stopband resulting from different combinations of patch shapes and branch shapes. The correlation may include “baseline” values of stopband for a particular array of patches, i.e., the stopband that would result by interconnecting the particular array of patches with non-undulating branches having a branch length substantially equal to the patch spacing.

The correlation may be determined empirically, or the correlation may be determined mathematically using techniques either now know or developed in the future. The correlation, as embodied in the record, may then be consulted when designing an EBG structure for a particular device. The record may be provided in the form of a lookup table, for example, and the lookup table may be consulted to select physical parameters of the undulating branches for tuning the stopband.

In step 102, a periodic structure of conductive patches is selected for the EBG structure. The periodic structure of conductive patches may be selected, for example, in view of the quantity and type of the various circuits to be included on the EBG structure. For example, a sufficient number of patches may be desired to ensure that the analog circuits and digital circuits may be located on different patches.

In step 104, a target stopband is selected. The target stopband may be selected, for example, in consideration of the operating frequencies of the various circuits to be included on the patches, such as to minimize any noise coupling.

In step 106, a baseline stopband of the selected periodic structure is determined. If the baseline stopband were optionally included in the correlation determined in step 102, then the baseline stopband may be determined by consulting the record (e.g. physical or electronic database) of the correlation. If the baseline stopband is dramatically different than the target stopband, then step 102 may be repeated to select a different periodic structure of conductive patches having a baseline stopband closer to the target stopband. Thus, steps 102 and 106 may be performed iteratively until a periodic structure of patches has been determined that accommodates all the desired circuits with adequate separation and has an acceptable baseline stopband.

In step 108, the stopband may be tuned by selecting branch parameters, such as the number of undulations, undulation height, and branch thickness, with the goal of achieving a stopband that is closer than the baseline stopband to the target stopband. Again, the steps outlined in the flowchart of FIG. 8 may be performed iteratively to select a combination of patch parameters and branch parameters that most closely achieves the target stopband, yet within certain other design constraints such as the space allocated to a PCB on which the EBG structure is to reside.

Additional design considerations will also affect the stopband of the EBG structure. For example, varying the dielectric material will result in a different frequency shift or stopband, assuming the same patch and branch parameters. However, the correlation determined in this method can be expanded to include different dielectric materials. Also, some deviation from the stopband predicted on the basis of the correlation may occur in different devices. For example, the positioning and quantity of via clearances in a circuit board may also have an effect on the resulting stopband of the EBG structure. However, the correlation remains useful in at least approximating the expected stopband, and remains a useful reference tool, particularly when using an iterative design process. By using the correlation, the number of design iterations is reduced.

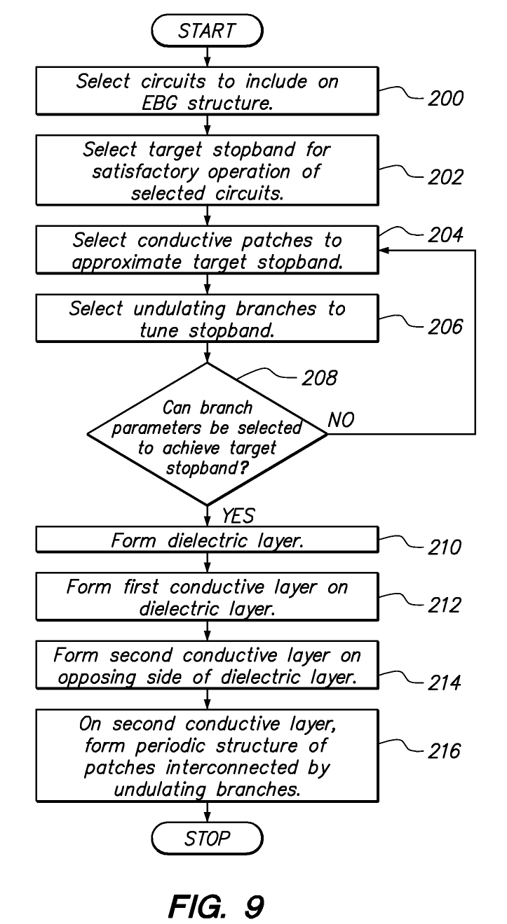

The invention further encompasses, in various other embodiments, methods of circuit manufacture. FIG. 9 is a flowchart outlining a method of manufacturing a stopband structure for an electronic device, such as a computer, cell phone, PDA, or high-speed chip testing board, according to another embodiment of the invention. The outlined method includes some design considerations. For example, in step 200, various circuits are selected to be included on an EBG structure to be manufactured. The selected circuits may include digital and analog circuits to be noise shielded by the EBG structure. Step 200 may include selecting circuits for an entirely new device. Alternatively, step 200 may include surveying the circuits and architecture of an existing electronic device design that the designer would like to improve, and selecting some or all of the same circuits to be included in the new device design incorporating the EBG structure to be manufactured.

Step 202 involves selecting a target stopband for satisfactory operation of the circuits selected in step 200. The target stopband may be selected in view of the operational frequency of the selected devices. For example, the target stopband may be a range of frequencies that includes the operational frequencies of sensitive analog circuits. Thus, noise from other circuits may be suppressed in the frequency range that would affect the operation of other circuits.

Step 204 involves selecting conductive patches for approximating the target stopband. The size, shape, and spacing of the conductive patches all influence the actual stopband achieved by the EBG structure, so judicious selection of these parameters may go a long way toward achieving the target stopband. However, in many cases, other design parameters, such as the space allocated to the EBG structure, will limit how closely the target stopband may be approximated by selecting conductive patches. Therefore, step 206 involves selecting undulating branches to tune the stopband, for the purpose of more closely approximating the target stopband. Physical parameters of the undulating branches, such as the number of undulations, branch thickness, and height, may be selected to precisely tune the stopband, and ideally to achieve the target stopband. As indicated by conditional step 208, the selection of patches (step 204) and branches (step 206) may be an iterative process, whereby different combinations of patch parameters and undulating branch parameters are considered to determine the combination of patch and branch parameters that most closely achieves the target stopband. In this respect, the method of manufacture outlined in FIG. 9 includes design aspects. Furthermore, a correlation between physical parameters of the patches, undulating branches, and the associated stopband may be consulted in the selection of patches and branches, such as described in the discussion of the design method of FIG. 8.

Once a combination of patches and undulating branches has been selected (steps 204-208), the EBG structure may be formed. In step 210, a dielectric layer is formed. In step 212, a first conductive layer is formed on one side of the dielectric layer. In step 214, a second conductive layer is formed on the other side of the dielectric layer (i.e., the side opposite the first dielectric layer). In step 216, the periodic structure comprising the selected patches and branches is formed on the second conductive layer. The process of layering the first and second conductive layers on the dielectric layer may be performed using various PCB manufacturing techniques. Likewise, the process of forming the EBG structure in the second conductive layer may also be performed using PCB manufacturing techniques, such as by etching.

The principles discussed above in the discussion of EBG embodiments may be applied to photonic band gap structures (“PBG”), too. Most PBG structures are implemented by creating periodic defects such as holes at a material which is not a conductor. Thus, in another embodiment, changing the distance between each defect will result in tuning effects similar to what the change to the undulation of branch does for EBG structures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A band gap structure, comprising:
a dielectric layer;
a first conductive layer disposed on a first side of the dielectric layer; and
a second conductive layer disposed on an opposing side of the dielectric layer, the second conductive layer comprising an array of spaced-apart patches interconnected by a plurality of branches, with each branch connecting two adjacent patches and having one or more undulations such that the length of each branch exceeds the physical spacing between the adjacent patches.

2. The apparatus of claim 1, wherein each branch comprises between one and three undulations.

3. The apparatus of claim 1, wherein the undulations comprise alternating U-shaped
turns.

4. The apparatus of claim 3, wherein segments of the U-shaped turns meet at generally right angles.

5. The apparatus of claim 1, further comprising:
one or more analog circuits coupled to one or more of the patches; and one or more digital circuits coupled to one or more other of the patches.

6. The apparatus of claim 1, wherein the array of electrically conductive patches form a rectangular array with substantially evenly-spaced patches.

7. The apparatus of claim 1, wherein the first conductive layer is a power layer and the second conductive layer is a ground layer.

8. The apparatus of claim 1, wherein the first conductive layer is a ground layer and the second conductive layer is a power layer.

9. A method of designing a band gap structure, comprising
selecting a periodic structure including conductive patches spaced apart in a conductive layer; and
selecting physical parameters for undulating branches used to connect the conductive patches for tuning a resulting stopband.

10. The method of claim 9, further comprising correlating the stopband of one or more periodic structures in combination with one or more physical parameters associated with the undulating branches; and
consulting the correlation in the step of selecting physical parameters for the undulating branches.

11. The method of claim 9, wherein the physical parameters for the undulating branches are selected from the group consisting of a number of undulations per branch, an undulation shape, an undulation height, and a branch length, wherein the branch length is greater than a spacing between adjacent patches.

12. The method of claim 9, further comprising:
selecting a target stopband for the electronic device;
determining a baseline stopband for the periodic structure of conductive patches assuming non-undulating branches; and
selecting the physical parameters of the undulating branches that more closely achieves the target stopband than the baseline stopband.

13. The method of claim 12, wherein the step of selecting the set of physical parameters comprises selecting the number of undulations per branch that shifts the stopband from the baseline stopband toward the target stopband.

14. The method of claim 12, further comprising:
selecting a branch length that more closely achieves the target stopband than the baseline stopband; and
selecting an undulating shape for the branches having the branch length.

15. A method of manufacturing a stopband structure, comprising forming a periodic structure of spaced-apart conductive patches interconnected by undulating branches each having a branch length exceeding the physical spacing between adjacent patches.

16. The method of claim 15, further comprising:
disposing a first conductive layer on one side of the dielectric layer; and
forming the periodic structure in a second conductive layer disposed on an opposing side of the dielectric layer.

17. The method of claim 16, further comprising:
etching the conductive patches in the second conductive layer;
etching straight branches interconnecting the conductive patches; and
further etching the straight branches to form the undulating branches.

18. The method of claim 15, further comprising:
selecting a target stopband; and
selecting the physical parameters of the undulating branches to substantially achieve the target stopband.

19. The method of claim 15 further comprising:
forming one or more analog circuits on at least one of the conductive patches; and
forming one or more digital circuits on at least one other of the conductive patches.

20. The method of claim 19, wherein the step of selecting the target stopband comprises selecting a stopband in the operational frequency of the one or more analog circuits.
